(19) United States
(12) Patent Application Publication
(10) Pub. No.: US 2024/0207132 A1
(43) Pub. Date: Jun. 27, 2024

(54) BEAUTY DEVICE WITH ROLLERS

(71) Applicant: EUNSUNG GLOBAL CORP., Gangwon-do (KR)

(72) Inventor: Ki Se LEE, Seoul (KR)

(21) Appl. No.: 18/145,659

(22) Filed: Dec. 22, 2022

(51) Int. Cl. A61H 15/00

(52) U.S. Cl. CPC A61H 15/0092; A61H 2015/0042

(57) ABSTRACT

A beauty device with rollers is proposed. The beauty device with rollers includes a main body part held by a user in his/her hand, a pair of rotating body support parts, each of which has one end coupled to the main body part, the rotating body support parts having an angle θ1 therebetween in a V-shape, and a pair of rotating body units coupled to the pair of rotating body support parts respectively, the rotating body units being configured to be rotated to massage the skin, wherein each of the rotating body units includes a shaft part having a step and an inclined one side, a first bearing part inserted into the shaft part, a second bearing part inserted into the shaft part, a roller part rotatably coupled to each of the rotating body support parts, and a nut part having a through hole inside.

### BACKGROUND OF THE INVENTION

### Field of the Invention

The present disclosure relates to a beauty device with rollers.

### Description of the Related Art

Unless expressly indicated otherwise, the contents explained in this section do not refer to any related art against the claims of the present application to be described below. In addition, it is not admitted that any art described in this section implies that the art is related to the present disclosure.

As human aging progresses, the muscles of the human face loose elasticity, causing wrinkles to be generated or the skin's sagging to occur. According to development of the beauty industry, devices for skin care have been developed so as to prevent wrinkles and sagging of the skin (in particular, the face) visible to the naked eye.

By way of example, there are beauty devices that can increase generation of collagen and elastic fibers through electric stimulus and reproduce skin cells, and in addition, make the skin healthy and elastic due to stimulating cell reproduction and increased blood flow, thereby enabling skin protection and care.

According to the related art, a ball-shaped rotating body is rotatably coupled to a handpiece and an electric stimulus generator is formed inside the handpiece, so as to transmit the electric stimulus to the rotating body.

However, the related art has been problematic in that an axis is warped while the rotating body is rotated for massaging, causing low frequency delivery to be discontinued or low frequency intensity to vary, and the related art has defects such that the massaging effect cannot be obtained as pulling of the skin is too excessive or skin stimulation is too minimal in the process of rolling the rotating body in a state that the rotating body comes into contact with the skin.

### RELATED ART DOCUMENTS

### Patent Document

1. Korean Patent No. 10-1773508 (published on Sep. 1, 2017)

### SUMMARY OF THE INVENTION

Accordingly, the present disclosure has been made keeping in mind the above problems occurring in the related art, and an objective of the present disclosure is to provide a beauty device with rollers, in which a pair of rotating body units coupled to form a predetermined angle therebetween are in no contact with a shaft part and rotate around the shaft part as a central axis, the skin is massaged as the rotating body units rotate and the skin is rolled and entered between roller parts if the roller parts come into close contact with the skin and are rolled, and simultaneously, if low frequency is applied from a main body unit to the rotating body unit, the roller part transmits the low frequency to the skin, thereby enabling the cosmetic effect to be maximized.

It should be understood that the scope of the present disclosure shall not be limited to the technical problems described above, and it is obvious that another technical problem may be derived from the description of the present disclosure to be described below.

In order to achieve the objective of the present disclosure, the present disclosure provides a beauty device with rollers. The beauty device includes a main body part held by a user in his/her hand, a pair of rotating body support parts, each of which has one end coupled to the main body part, the rotating body support parts having an angle (θ1) therebetween in a V-shape, and a pair of rotating body units coupled to the pair of rotating body support parts respectively, the rotating body units being configured to be rotated to massage the skin, and each of the rotating body units may include a shaft part provided with a step extended in diameter, the shaft part having an inclined side on which a tapered surface is formed, a first bearing part formed in close contact with the step, and inserted into the shaft part, a second bearing part inserted into the shaft part, being spaced apart from the first bearing part at a predetermined interval, a roller part rotatably coupled to each of the rotating body support parts, and having an insertion recess into which a part of the shaft part is inserted and being in close contact with an outer circumferential surface of the second bearing part, thereby rotating around the shaft part, and a nut part having a thorough hole inside, thereby allowing an inner circumferential surface thereof to be rotatably coupled to an outer circumferential surface of the first bearing part and allowing an outer circumferential surface thereof to be rotatably coupled to an inner circumferential surface of the roller part.

The shaft part has at an outside thereof a first ring groove in which the first bearing part is arranged, and each of the rotating body units may further include a first snap ring part inserted into the second bearing part at the first ring groove, the first snap ring part being larger than an outer diameter of the shaft part and being cut at one side thereof, thereby being in close contact with the first bearing part.

The shaft part has at an outside thereof a second ring groove in which the second bearing part is arranged, and each of the rotating body units may further include a second snap ring part inserted into the first bearing part at the second ring groove, the second snap ring part being larger than an outer diameter of the shaft part and being cut at one side thereof, thereby being in close contact with the second bearing part.

The roller part and the nut part may be screw-coupled to each other.

Each of the rotating body units may further include a packing part having an elastic component, the packing part being in contact with the nut part, and coming into close contact with the insertion recess of the roller part, and a ring-type ring support part inserted into the packing part, thereby fixing the packing part.

The roller part includes a support groove larger than an outer diameter of the packing part, and each of the rotating body units may further include a fixed support part inserted into the support groove, the fixed support part having one side which is open, being configured to prevent decoupling of the first bearing part, the nut part, the packing part, and the ring support part.

Each of the rotating body units may further include a spring part having one side in contact with the insertion recess of the roller part and an opposite side in contact with both a tapered one side of the shaft part and the second bearing part, thereby delivering electrons and wavelength to the roller part and elastically supporting the second bearing part.

An angle θ1 between the pair of rotating body support parts is in a range of 55° to 90°.

The pair of rotating body support parts are formed inclinedly toward a front of the main body part, and an angle θ2 between a front surface of the main body part and the rotating body support parts is in a range of 110° to 180°.

A distance ( [symbol] ) between the pair of roller parts is in a range of 5 to 7.9 mm.

The present disclosure is advantageous in that as a roller part is supported and rotated by two bearings, the skin is massaged as the roller part rotates, preventing low frequency delivery from being discontinued or low frequency intensity from varying due to sagging of the axis, which enables stable rotation of the roller part and stable delivery of the low frequency at uniform intensity to the skin.

The packing part comes into close contact with the insertion recess of the roller part to support the nut part, thereby preventing water or foreign matter from being introduced toward the nut part and the first bearing part.

The fixed support part is coupled by insertion to the support groove of the roller part, thereby preventing decoupling of the first bearing part, the nut part, the packing part, and the ring support part.

The spring part is configured to have the shaft part and the roller part communicate with each other, preventing abrasion of the shaft part due to direct contact with the insertion recess of the roller part, or occurrence of poor electricity transmission occurring due to poor connection or defects such as low frequency disturbance, etc., thereby allowing electrons or wavelength to be effectively transmitted to the roller part.

An angle and a distance between a plurality of roller parts are optimized, thereby greatly improving a massaging effect with less pain.

Assembling of the rotating body unit is simple, thereby producing an effect of improving productivity.

Effects of the present invention are not limited to the effects described above, and another effects that are not described herein could be clearly understood by those skilled in the art from the description of the accompanying claims.

### BRIEF DESCRIPTION OF THE DRAWINGS

The above and other objectives, features, and other advantages of the present disclosure will be more clearly understood from the following detailed description when taken in conjoint with the accompanying drawings, in which:

FIG. 1 is a top view of a beauty device with rollers according to an exemplary embodiment of the present disclosure;

FIG. 2 is a front view of a beauty device with rollers according to an exemplary embodiment of the present disclosure;

FIG. 3 is a perspective view of a rotating body unit of a beauty device with rollers according to an exemplary embodiment of the present disclosure;

FIGS. 4 and 5 are exploded perspective views of FIG. 3;

FIG. 6 is a cross sectional view taken along line CL of FIG. 2; and

FIGS. 7 to 10 are schematic cross sectional views illustrating an assembling sequence of a rotating body unit of a beauty device with rollers according to an exemplary embodiment of the present disclosure.

### DETAILED DESCRIPTION OF THE INVENTION

Hereinafter, configurations and operation effects of preferred embodiments of the present disclosure will be described with reference to the accompanying drawings. For convenient and explicit description, components may be omitted or schematically illustrated in the drawings, and sizes of the respective components do not reflect actual sizes thereof. In addition, throughout the specification, the same reference numerals will refer to the same or like parts, and the reference numerals for the same configuration will be omitted in the drawings.

Hereinbelow, the beauty device 900 with rollers according to an exemplary embodiment of the present disclosure will be described in detail with reference to the accompanying drawings.

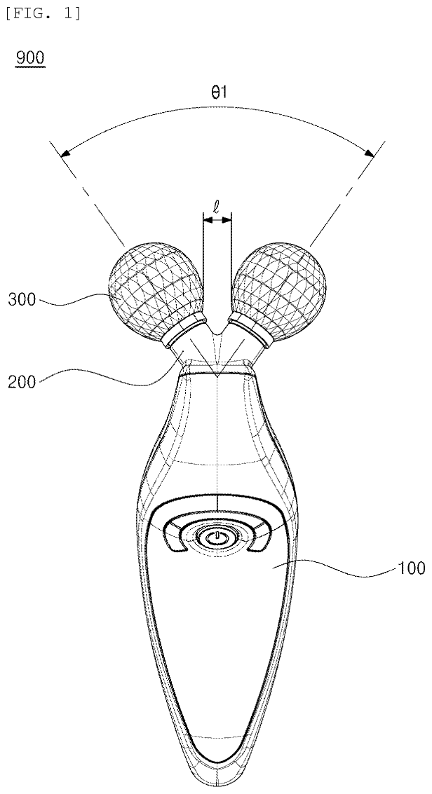

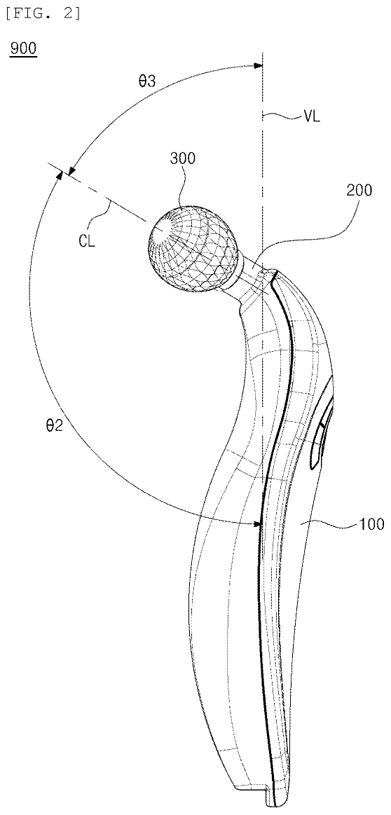

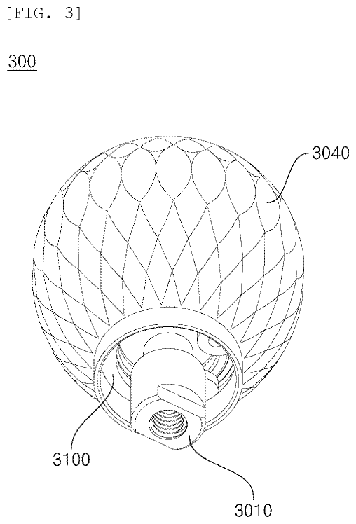

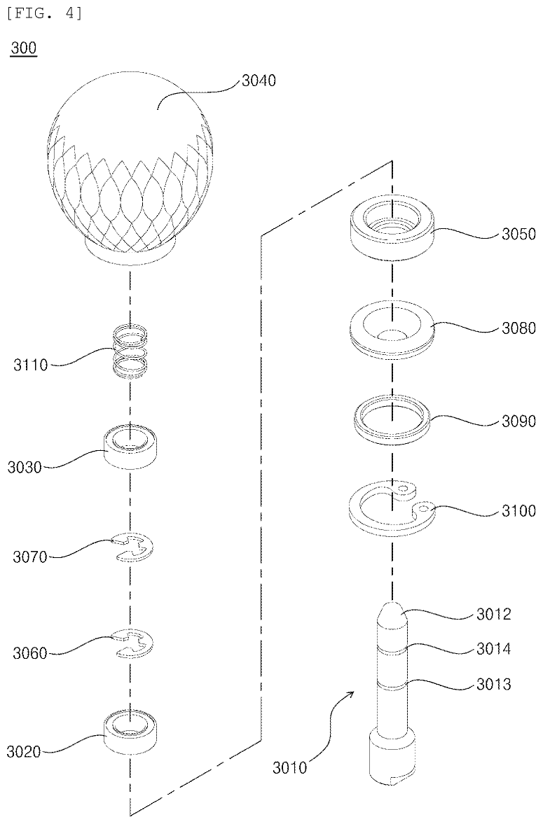

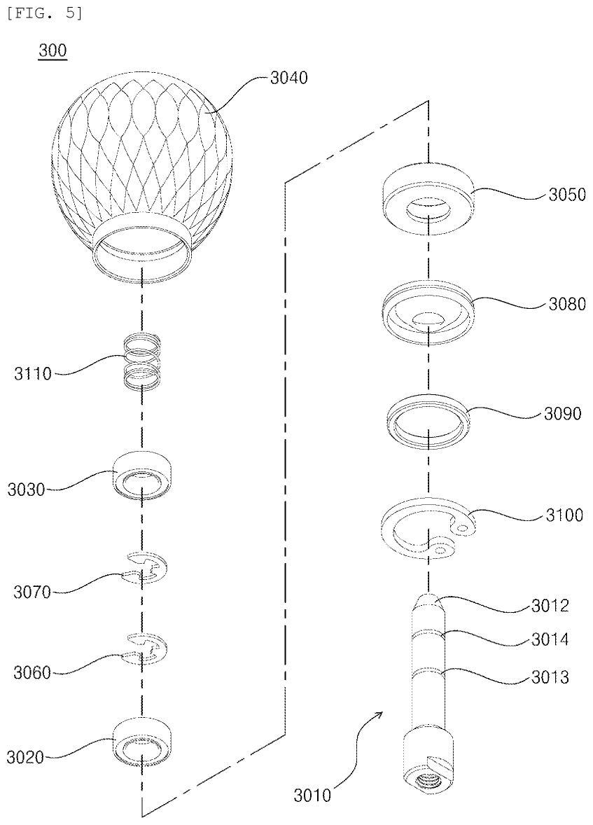

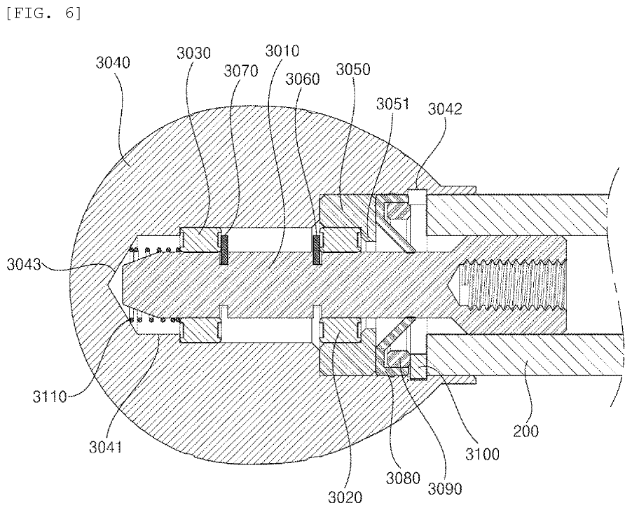

FIG. 1 is a top view of a beauty device 900 with rollers according to an exemplary embodiment of the present disclosure, FIG. 2 is a front view of a beauty device 900 with rollers according to an exemplary embodiment of the present disclosure, FIG. 3 is a perspective view of a rotating body unit 300 of a beauty device 900 with rollers according to an exemplary embodiment of the present disclosure, FIGS. 4 and 5 are exploded perspective views of FIG. 3, and FIG. 6 is a cross sectional view taken along line CL of FIG. 2.

The present disclosure relates to a beauty device 900 with rollers, in which in which a pair of rotating body units 300 coupled to form a predetermined angle therebetween rotate around the shaft part 3010 as a central axis, the skin is massaged as the rotating body units 300 rotate and the skin is rolled and entered between roller parts 3040 if the roller parts 3040 come into close contact with the skin (in particular, face) and are rolled, and simultaneously, if low frequency is applied from a main body unit 100 to the rotating body unit 300, the roller part 3040 comes into close contact with the skin and transmits the low frequency to the skin, thereby enabling the cosmetic effect to be maximized. The beauty device 900 with rollers according to an exemplary embodiment of the present disclosure may include a main body part 100, a rotating body support part 200, a rotating body unit 300, etc.

The beauty device 900 with rollers according to an exemplary embodiment of the present disclosure includes a main body part 100 held by a user in his/her hand, a pair of rotating body support parts 200, each of which has one side coupled to the main body part 100, the rotating body support parts 200 having an angle θ1 therebetween in a V-shape, and a pair of rotating body units 300 coupled to the pair of rotating body support parts 200 respectively, the rotating body units being configured to be rotated to massage the skin, wherein each of the rotating body units 300 includes a shaft part 3010 provided with a step 3011 extended in diameter, the shaft part having an inclined side on which a tapered surface 3012 is formed, a first bearing part 3020 formed in close contact with the step 3011, and inserted into the shaft part 3010, a second bearing part 3030 inserted into the shaft part 3010, being spaced apart from the first bearing part 3020 at a predetermined interval, a roller part 3040 rotatably coupled to each of the rotating body support part 200, having an insertion recess 3041 into which a part of the shaft part 3010 is inserted and being in close contact with an outer circumferential surface of the second bearing part 3030, thereby rotating around the shaft part 3010, and a nut part 3050 having a thorough hole inside, thereby allowing an inner circumferential surface thereof to be rotatably coupled to an outer circumferential surface of the first bearing part 3020 and an outer circumferential surface thereof to be rotatably coupled to an inner circumferential surface of the roller part 3040. The shaft part 3010 has at an outside thereof a first ring groove 3013 in which the first bearing part 3020 is arranged, and each of the rotating body unit 300 further includes a first snap ring part 3060 inserted into the second bearing part 3030 at the first ring groove 3013, the snap ring part 3060 being larger than an outer diameter of the shaft part 3010 and being cut at one side thereof, thereby being in close contact with the first bearing part 3020. The shaft part 3010 has at an outside thereof a second ring groove 3014 in which the second bearing part 3030 is arranged, and each of the rotating body units 300 further includes a second snap ring part 3070 inserted into the first bearing part 3020 at the second ring groove 3014, the second ring part 3070 being larger than an outer diameter of the shaft part 3010 and being cut at one side thereof, thereby being in close contact with the second bearing part 3030. The roller part 3040 and the nut part 3050 may be screw-coupled to each other.

As illustrated in FIG. 1 or 2, the main body part 100 is a part which is gripped by a user in his/her hand. For easy gripping, the main body part 100 may be approximately in a streamlined shape. Seeing the main body part 100 in front thereof, the main body part 100 may be convex in shape.

As illustrated in FIG. 1, the rotating body support parts 200 in a pair extend to form a V-shape, having an angle θ1 between the pair of the rotating body support parts 200. One side of each rotating body support part 200 is coupled to the main body part 100 and an opposite side thereof is rotatably coupled to the rotating body unit 300 to be described below, thereby serving to support the rotating body unit 300.

By way of example, the rotating body support part 200 is formed of such a material that can conduct electricity transmitted from the main body part 100, preferably including brass, copper, stainless, aluminum, etc. which have high electrical conductivity.

The pair of rotating body units 300 are rotatably coupled to the pair of rotating body supporting parts 200 respectively. The rotating body units 300 rotate to massage the skin and applies low frequency to the skin, thereby serving to improve the skin care. Each of the rotating body units 300 may include a shaft part 3010, a first bearing part 3020, a second bearing part 3030, a roller part 3040, a nut part 3050, a first snap ring part 3060, a second snap ring part 3070, a packing part 3080, a ring support part 3090, a fixed support part 3100, a spring part 3110, etc.

The shaft part 3010 is provided with a step 3011 extended in diameter, and has an inclined side forming a tapered surface 3012 which is inserted into the roller part 3040 to be described below and an opposite side which is coupled by insertion to the rotating body support part 200, serving as a rotation axis around which the roller part 3040 rotates. The shaft part 3010 may include a step 3011, a tapered surface 3012, a first ring groove 3013, and a second ring groove 3014, etc.

As illustrated in FIGS. 4 to 10, the shaft part 3010 may be configured to have an inclined side at which a tapered surface 3012 is formed, or may be formed in an arc-rounded shape.

As an example, a first ring groove 3013 to be described below is formed at a portion to which the first bearing part 3020 of the shaft part 3010, which will be described below, is coupled, and a step 3011 of the shaft part 3010, extended in diameter, may be provided. In addition, the shaft part 3010 is configured in such a manner that the tapered one side is not in contact with the insertion recess 3041 of the roller part 3040, which will be described below, thereby generating no problem such as abrasion due to contact of the shaft part 3010 and the insertion recess 3041 of the roller part 3040 or low frequency disturbance due to contact failure, etc.

As an example, the shaft part 3010 may be formed of a material that can conduct electricity transmitted from the main body part 100, including brass, copper, stainless, aluminum, etc., which have high electrical conductivity.

The first bearing part 3020 is inserted into the first ring groove 3013 formed in the shaft part 3010, which will be to be described below, and is closely coupled to the step 3011, thereby serving to rotate the roller part 3040 to be described below, around the shaft part 3010.

The second bearing part 3030 is coupled by insertion to the second ring groove 3014 formed in the shaft part 3010, which will be described below, and is spaced apart from the first bearing part 3020 at a predetermined interval, thereby serving to rotate the roller part 3040 to be described below together with the first bearing part 3020 around the shaft part 3010.

As illustrated in FIG. 6, the second bearing part 3030 is in contact with the insertion recess 3041 of the roller part 3040 to be described below, and is rotatably coupled to the roller part 3040, thereby allowing the roller part 3040 to be supported by the second bearing part 3030 and to rotate around the shaft part 3030.

The roller part 3040 is rotatably coupled to the rotating body support part 200 by an opened side thereof and comes into close contact with an outer circumferential surface of the second bearing part 3030, thereby rotating around the shaft part 3010, which serves to provide massage and low frequency while the roller part 3040 is in contact with the skin. The roller part 3040 may include an insertion recess 3041, a support groove 3042, etc.

As illustrated in FIGS. 1 to 5, the roller part 3040 may be formed with multiple faces in an external surface thereof to give stimulus to the skin tissue of a user, which are portions in contact with the user's skin.

By way of example, the roller part 3040 may emit current such as low frequency generated from the main body part 100, which is received through the shaft part 3010 and a spring part 3010 to be described below, into the user's skin. For this, the roller part 3040 is preferably formed of a material having high electrical conductivity, which may include brass, copper, stainless, aluminum, etc.

As illustrated in FIG. 6, the insertion recess 3041 inside the roller part 3040 is formed from the open side of the roller part 3040 into which the shaft part 3010 is inserted, and the insertion recess 3041 may include a cylindrical shape whose diameter is changed.

As illustrated in FIG. 6, the end of the tapered one side of the shaft part 3010 is not in contact with a conical end 3043, which is an inclined bottom of the insertion recess 3041, thereby serving to prevent abrasion of the shaft part 3010.

The nut part 3050 has a through hole inside, and an inner circumferential surface thereof is rotatably coupled to an outer circumferential surface of the first bearing part 3020 and an outer circumferential surface thereof is rotatably coupled to an inner circumferential surface of the roller part 3040, thereby enabling the roller part 3040 to rotate around the shaft part 3010. The nut part 3050 may include a stopper part 3051.

By way of example, a thread is formed on an outer circumferential surface of the nut part 3050, and a thread corresponding the thread is also formed on an inner circumferential surface of the insertion recess 3041 of the roller part 3040. The roller part 3040 and the nut part 3050 can be screw-coupled to each other. As illustrated in FIG. 6, one side end of the nut part 3050 may be provided with a stopper part 3051 with a reduced diameter of the through hole, and the nut part 3050 may allow the stopper part 3051 to support the first bearing part 3020 when the nut part 3050 is coupled to the roller part 3040, so that the roller part 3040 can come into close contact with the shaft part 3010.

As illustrated in FIGS. 4 to 7, a first ring groove 3013 and a second ring groove 3014 spaced apart from the first ring groove 3013 may be formed on an outer circumferential surface of the shaft part 3010, the first ring groove 3013 being formed outside at which the first bearing part 3020 is disposed, causing the diameter of the shaft part 3010 to be reduced, and the second ring groove 3014 being formed outside at which the second bearing part 3030 is disposed, causing the diameter of the shaft part 3010 to be reduced.

A first snap ring part 3060 is inserted into the second bearing part 3030 at the first ring groove 3013 to come into close contact with the first bearing part 3020, thereby serving to prevent the first bearing part 3020 from being displaced.

As illustrated in FIGS. 4 to 6, the first snap ring part 3060 is formed of a disc-shaped member, having an inner diameter corresponding to the outer circumferential surface of the first ring groove 3013, and may extend to have an outer diameter larger than an outer diameter of the shaft part 3010. The first snap ring part 3060 may be formed in such a manner that one side thereof is cut so as to be inserted into the first ring groove 3013. By way of example, the first bearing part 3020 may be fixed in position on the shaft part 3010 by the first snap ring part 3060 and the step 3011 provided in the shaft part 3010.

A second snap ring part 3070 is inserted into the first bearing part 3020 at the second ring groove 3014 to come into close contact with the second bearing part 3030, serving to prevent the second bearing part 3030 from being displaced.

As illustrated in FIGS. 4 to 6, the second snap ring part 3070 is formed of a disc-shaped member, having an inner diameter corresponding to the outer circumferential surface of the second ring groove 3014, and may extend to have an outer diameter larger than an outer diameter of the shaft part 3010. The second snap ring part 3070 may be formed in such a manner that one side thereof is cut so as to be inserted into the second ring groove 3014. By way of example, the second bearing part 3030 may be fixed in position on the shaft part 3010 by the second snap ring part 3070 and the spring part 3110 to be described below.

The rotating body unit 300 is in contact with the nut part 3050 so as to comes into close contact with the insertion recess 3041 of the roller part 3040. The rotating body unit 300 further includes a packing part 3080 including an elastic component, and a ring-type ring support part 3090 inserted into the packing part 3080 to fix the packing part 3080. The roller part 3040 includes a support groove 3042 larger than an outer diameter of the packing part 3080. The rotating body unit 300 may further include a fixed support part 3100 being inserted into the support groove 3042 and having an open side, thereby preventing decoupling of the first bearing part 3020, the nut part 3050, the packing part 3080, and the ring support part 3090, and a spring part 3110 including an elastic component and having one side in contact with the insertion recess 3041 of the roller part and an opposite side in contact with the tapered one side of the shaft part 3010 and the second bearing part 3030, thereby delivering electrons and wavelength to the roller part and supporting the second bearing part 3030,

The packing part 3080 is in contact with the nut part 3050 to come into close contact with the insertion recess 3041 of the roller part 3040, serving to support the nut part 3050 and to prevent water or foreign matter from being introduced toward the nut part 3050 and the first bearing part 3020. By way of example, the packing part 3080 may include silicon as an elastic component so as to come into close contact with the insertion recess 3041, thereby making waterproof.

The ring support part 3090 is in a ring shape and inserted into the packing part 3080, functioning to fix the packing part 3080. As illustrated in FIG. 4 or 5, the packing part 3080 is depressed from the top to the bottom, having an open central portion, the packing part 3080 having an opening smaller than the lower opening, and the ring support part 3090 is inserted into the packing part 3080 from the bottom to the top, enabling the packing part 3080 to be supported.

The fixed support part 3100 is inserted into the support groove 3042 of the roller part 3040, which will be described below, thereby serving to prevent decoupling of the first bearing part 3020, the nut part 3020, the packing part 3050, and the ring support parts.

As illustrated in FIG. 6, the support groove 3042 has the largest diameter in the insertion recess 3041 of the roller part 3040 and is formed to be larger than an outer diameter of the packing part 3080. The fixed support part 3100 is coupled by insertion to the support groove 3042, thereby serving to prevent decoupling of the first bearing part 3020, the nut part 3050, the packing part 3080, and the ring support part 3090. As illustrated in, the fixed support part 3100 may be formed with one side which is open.

The spring part 3110 has elastic force, and having one side in contact with the insertion recess 3041 of the roller part 3040 and an opposite side in contact with the tapered one side of the shaft part 3010 and the second bearing part 3030, thereby serving to deliver electrons and wavelength to the roller part 3040 and support the second bearing part 3030.

As illustrated in FIGS. 4 to 6, the spring part 3110 is configured to have the shaft part 3010 and the roller part 3040 communicate with each other, thereby preventing abrasion due to direct contact of the shaft part 3010 and the insertion recess 3041, or poor electricity transmission occurring due to poor connection or defects such as low frequency disturbance, etc.

The beauty device 900 with rollers according to an exemplary embodiment of the present disclosure may feature that an angle θ1 between the pair of rotating body support parts 200 is in a range of 55°˜90°, and the pair of rotating body support parts 200 is formed to be inclined toward a front of the main body part 100, an angle θ2 between the front surface of the main body part 100 and the rotating body support part 200 is in a range of 110° ˜180°, and a distance [symbol] between the pair of roller parts 3040 is in a range of 5 to 7.9 mm.

As illustrated in FIG. 1, the pair of rotating body support parts 200 can be separated symmetrically from each other by a predetermined angle θ1. On the basis of a virtual central line shown in the main body part 100, the pair of rotating body support parts 200 are formed symmetrically to each other, and an angle θ1 therebetween is preferably in a range of 55° to 90°.

For example, if the angle θ1 between the pair of rotating body support parts 200 is 55° or less, the skin is excessively pulled, causing pain, and if the angle θ1 between the pair of rotating body support parts 200 is 90° or more, adherence to the skin is degraded, leading to reduction of the massaging effect.

As illustrated in FIG. 2, the pair of rotating body support parts 200 are formed to be inclined toward a front of the main body part 200, so that a front surface of the main body part 100 and the rotating body support part 200 can have a predetermined angle θ2 therebetween.

By way of example, an angle between the bottom of a virtual vertical line (VL) drawn in the center of the main body part 100 and a virtual central line (CL) passing by the center between the rotating body support part 200 and the roller part 3040 is defined as an angle θ2. Preferably, it would be proper that the angle between the front surface of the main body part, and the rotating body support part 200 and the roller part 3040 is in a range of 110° to 180°.

For example, if the angle θ2 between the front surface of the main body part 100, and the rotating body support part 200 and the roller part 3040 is 110° or less, the skin is excessively pulled, causing the pain, and if the angle θ2 is 180° or more, adherence to the skin is be degraded, which is liable to reduce the massaging effect.

In addition, as an example, an angle between the top of the virtual vertical line drawn in the center of the main body part 100 and a virtual central line (CL) passing by the center between the rotating body support part 200 the roller part 3040 may be defined as an angle θ3. θ3=180°−θ2.

As illustrated in FIG. 1, it would be proper that a distance [symbol] between a pair of roller parts 3040 is in a range of 5 to 7.9 mm.

As an example, if the distance [symbol] between the pair of roller parts 3040 is 5 mm or less, the skin is pinched between the two roller parts 3040, being likely to cause pain, and if the distance [symbol] between the pair of roller parts 3040 is 7.9 mm or more, adherence to the skin is degraded, being liable to reduce the massaging effect.

### EXPERIMENTAL EXAMPLES

Hereinbelow, specific experimental examples of the present disclosure will be described.

Table 1 indicates test results regarding an angle θ1 between the pair of rotating body support parts 200 tested in a range of 30° to 90°.

TABLE 1
Test of θ1

| Angle | Test result |
|---|---|
| Completely | Impossible to use |
| parallel | Difficult to roll |
| 30° | x |
| 40° | x |
| 50° | x |
| 55° | Δ |
| 60° | ○ |
| 65° | ○○ |
| 70° | ○○ |
| 75° | ○ |
| 80° | ○ |
| 85° | ○ |
| 90° | ○ |

(x: Difficult,
Δ: Normal,
○: Good,
○○: Very good)

Referring to Table 1, it can be known that the best rolling function is exhibited when the angle θ1 between the pair of rolling body support parts 200 is 65° and 70°.

Table 2 indicates test results regarding an angle θ2 between the front surface of the main body part 100 and the rotating body support part 200 tested in a range of 110° to 180°.

TABLE 2
Test of θ2

| Angle | Test result |
|---|---|
| 90° | × |
| 100° | Δ |
| 110° | ○ |
| 120° | ○○ |
| 130° | ○ |
| 140° | ○ |
| 150° | ○ |
| 160° | ○ |
| 170° | ○ |
| 180° | ○○ |

(x: Difficult,
Δ: Normal,
○: Good,
○○: Very good)

Referring to FIG. 2, it can be known that the best rolling function is exhibited when the angle θ1 between the front surface of the main body part 200 and the rolling body support part 200 is 120° and 180°.

Table 3 indicates test results regarding a distance [symbol] between the pair of the roller parts 3040 tested by changing the distance in the unit of 1 mm in a range of 3 to 10 mm.

TABLE 3
Test of

[symbol]

| Distance | Test result |
|---|---|
| 3 mm | × |
| 4 mm | Δ |
| 5 mm | ○ |
| 6 mm | ○ |
| 7 mm | ○○ |
| 8 mm | ○○ |
| 9 mm | ○ |
| 10 mm | ○ |

(x: Difficult,
Δ: Normal,
○: Good,
○○: Very good)

Referring to FIG. 3, it can be known that the optimal rolling function is exhibited when the distance [symbol] between the pair of rolling parts 3040 is 7 mm and 8 mm.

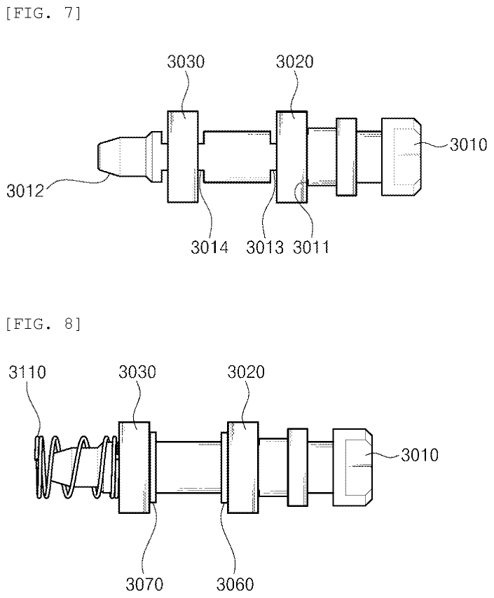

FIGS. 7 to 10 are schematic cross sectional views illustrating the assembling sequence of the rotating body unit 300 of the beauty device 900 with rollers according to an exemplary embodiment of the present disclosure.

As illustrated in FIG. 7, the first bearing part 3020 and the second bearing part 3030 are first spaced apart from each other at a predetermined interval and inserted into the shaft part 3010. One side of the first bearing part 3020 is supported by the step 3011, and the second bearing part 3030 is inserted at the position of the second ring groove 3014.

As illustrated in FIG. 8, the first snap ring part 3060 is fitted into the first ring groove 3013 at which the first bearing part 3020 is positioned, and the second snap ring part 3070 is fitted into the second ring groove 3014 at which the second bearing part 3030 is positioned, thereby fixing the positions of the first bearing part 3020 and the second bearing part 3030 in the shaft part 3010. In addition, the spring part 3110 may be inserted into one side of the shaft part 3010 and may come into contact with the second bearing part 3030.

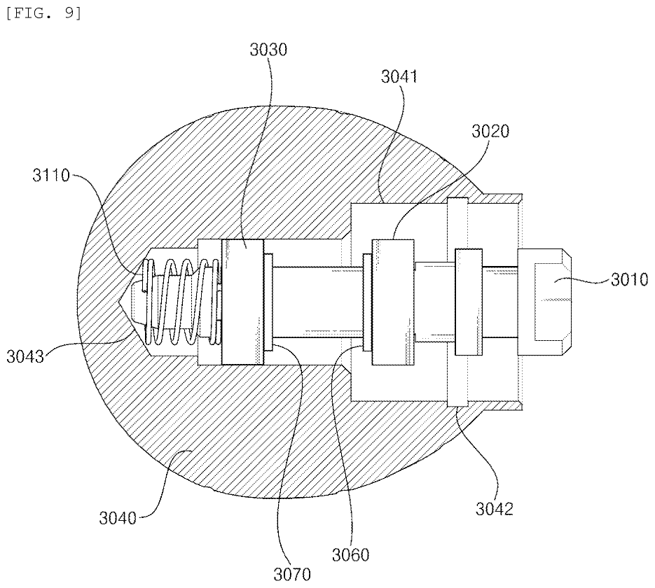

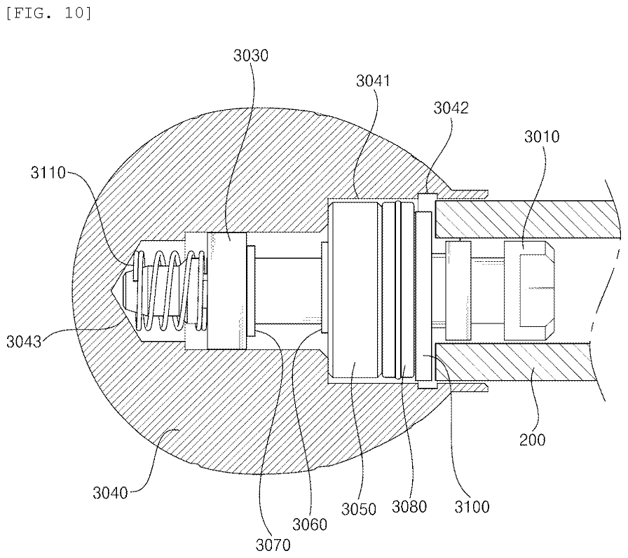

As illustrated in FIG. 9, the roller part 3040 is inserted into one side of the shaft part 3010, allowing the insertion recess 3041 of the roller part 3040 to come into close contact with the spring part 3110, and the shaft part 3010 and the conical end 3043 which is the insertion recess 3041 of the roller part 3040 do not come into contact with each other.

If a part of the shaft part 3010 is inserted into the insertion recess 3041 of the roller part 3040, the nut part 3050 is inserted into the shaft part 3010 at the open side of the roller part 3040, allowing the outer circumferential surface of the nut part 3050 and the inner circumferential surface of the insertion recess 3041 of the roller part 3040 to be coupled with each other. At this time, the roller part 3040 and the nut part 3040 may be screw-coupled to each other, and the stopper 3051 is provided in the through hole of the nut part 3050, supporting the first bearing part 3020, thereby allowing the roller part 3040 to come into close contact with the spring part 3110.

By way of example, after the nut part 3050 is coupled with the shaft part 3010, the packing part 3080 may be inserted thereinto, and after the ring support part 3090 is coupled by insertion to the packing part 3080, the fixed support part 3100 may be coupled by insertion to the support groove 3042.

Conventionally, there have been problems such that the axis is warped, causing discontinuation of low frequency delivery or change in low frequency intensity, etc. However, in the beauty device with rollers according to the present disclosure, as a roller part 3040 is supported and rotated by two bearings, axial shaking is prevented, thereby enabling stable rotation of the roller part 3040. In addition, the axial shaking is prevented and resistance due to change in contact regions of the roller part 3040 and the spring part 3110 is minimized, enabling low frequency at uniform intensity to be delivered to the skin stably. The roller part 3040 and the spring part 3110 are in circular linear contact with each other, producing an effect that change in friction and resistance between the stationary spring part 3110 and the rotating roller part 3040 can be minimized. The packing part 3080 is in close contact with the insertion recess 3041 of the roller part to support the nut part 3050, serving to prevent water or foreign matter from being introduced toward the nut part 3050 and the first bearing part 3020. The fixed support part 3020 is coupled by insertion to the support groove 3042 of the roller part 3040, serving to prevent decoupling of the first bearing part 3020, the nut part 3050, the packing part 3080, and the ring support part 3090. The spring part 3110 is configured to have the shaft part 3010 and the roller part 3040 communicate with each other, thereby preventing the shaft part 3010 from being abraded due to direct contact with the insertion recess 3041 of the roller part 3040 or poor electricity transmission occurring due to connection failure or defects such as low frequency disturbance, etc., which enables electrons or wavelength to be effectively transmitted to the roller part 3040. An angle and a distance between a plurality of roller parts 3040 are optimized, serving to greatly improve a massaging effect with less pain. Assembling of the rotating body unit is simple, producing an effect of improving productivity.

Preferred embodiments of the present disclosure have been described with respect to the accompanying drawings. However, the embodiments described in the specification and the configurations illustrated in the drawings of the present application are merely the most preferable exemplary embodiments of the present disclosure and they do not represent all technical the concepts of the present disclosure Those skilled in the art should appreciate that there have been various equivalents and modifications, etc. that could replace them at the time when the present application was filed. It should be understood that the embodiments described above have been disclosed for illustrative purposes, in all aspects, and the scope of the present disclosure is defined by the accompanying claims rather than the description which is presented above. Moreover, the present disclosure is intended to cover not only the exemplary embodiments, but also various alternatives, modifications, equivalents and other embodiments that may be derived from the spirit and scope, or equivalent concepts of the present disclosure as defined by the appended claims.

What is claimed is:

1. A beauty device with rollers, the beauty device comprising:
a main body part held by a user in his/her hand;
a pair of rotating body support parts, each of which has one end coupled to the main body part, the rotating body support parts having an angle (θ1) therebetween in a V-shape; and
a pair of rotating body units coupled to the pair of rotating body support parts respectively, the rotating body units being configured to be rotated to massage the skin,
wherein each of the rotating body units comprises:
a shaft part provided with a step extended in diameter, the shaft part having an inclined side on which a tapered surface is formed;
a first bearing part formed in close contact with the step, and inserted into the shaft part;
a second bearing part inserted into the shaft part, being spaced apart from the first bearing part at a predetermined interval;
a roller part rotatably coupled to each of the rotating body support parts, and having an insertion recess into which a part of the shaft part is inserted and being in close contact with an outer circumferential surface of the second bearing part, thereby rotating around the shaft part; and
a nut part having a thorough hole inside, thereby allowing an inner circumferential surface thereof to be rotatably coupled to an outer circumferential surface of the first bearing part and allowing an outer circumferential surface thereof to be rotatably coupled to an inner circumferential surface of the roller part.

2. The beauty device with rollers of claim 1, wherein the shaft part has at an outside thereof a first ring groove in which the first bearing part is arranged, and
each of the rotating body units further comprises a first snap ring part inserted into the second bearing part at the first ring groove, the first snap ring part being larger than an outer diameter of the shaft part and being cut at one side thereof, thereby being in close contact with the first bearing part.

3. The beauty device of rollers of claim 1, wherein the shaft part has at an outside thereof a second ring groove in which the second bearing part is arranged, and
each of the rotating body units further comprises a second snap ring part inserted into the first bearing part at the second ring groove, the second snap ring part being larger than an outer diameter of the shaft part and being cut at one side thereof, thereby being in close contact with the second bearing part.

4. The beauty device with rollers of claim 1, wherein the roller part and the nut part are screw-coupled to each other.

5. The beauty device with rollers of claim 1, wherein each of the rotating body units further comprises:
a packing part having an elastic component, the packing part being in contact with the nut part, and coming into close contact with the insertion recess of the roller part; and
a ring-type ring support part inserted into the packing part, thereby fixing the packing part.

6. The beauty device with rollers of claim 5, wherein the roller part comprises a support groove larger than an outer diameter of the packing part, and
each of the rotating body units further comprises a fixed support part inserted into the support groove, the fixed support part having one side which is open, being configured to prevent decoupling of the first bearing part, the nut part, the packing part, and the ring support part.

7. The beauty device with rollers of claim 1, wherein each of the rotating body units further comprises a spring part having one side in contact with the insertion recess of the roller part and an opposite side in contact with both a tapered one side of the shaft part and the second bearing part, thereby delivering electrons and wavelength to the roller part and elastically supporting the second bearing part.

8. The beauty device with rollers of claim 1, wherein an angle (θ1) between the pair of rotating body support parts is in a range of 55° to 90°.

9. The beauty device with rollers of claim 1, wherein the pair of rotating body support parts are formed inclinedly toward a front of the main body part, and an angle (θ2) between a front surface of the main body part and the rotating body support parts is in a range of 110° to 180°.

10. The beauty device with rollers of claim 1, wherein a distance ( [symbol] ) between a pair of roller parts is in a range of 5 to 7.9 mm.
